(19) United States
(12) Patent Application Publication
(10) Pub. No.: US 2002/0075368 A1
(43) Pub. Date: Jun. 20, 2002

(54) Packaging method and structure of an inkjet cartridge print head chip

(76) Inventors: Shyh-Haur Su, Hsinchu (TW); Chieh-Wen Wang, Hsinchu (TW); Chih-Ping Lu, I-Lan (TW)

Correspondence Address: LAW OFFICE OF LIAUH & ASSOC., 4224 WAIALAE AVE, STE 5-388, HONOLULU, HI, 96816

(21) Appl. No.: 09/927,725

(22) Filed: Aug. 9, 2001

(30) Foreign Application Priority Data
Dec. 15, 2000 (TW) 89126826

(51) Int. Cl. B41J 2/175

(52) U.S. Cl. 347/87

(57) ABSTRACT

The present invention pertains to a packaging method and the structure of an inkjet cartridge print head chip. The main technique disclosed herein is to package a chip substrate that can resist the corrosion of the ink at the ink cartridge outlet. A preferred embodiment is to package the chip substrate at the ink outlet at the same time when the inkjet cartridge is formed through plastic molding. Another preferred embodiment is to package the chip substrate at the ink cartridge outlet using ultrasonic or heat welding and then glue the print head on the chip substrate. These means can solve the problem of ink leakage in conventional ink cartridge because of the corrosion of ink to the glue between the print head chip and the ink cartridge.

### BACKGROUND OF THE INVENTION

1. Field of Invention

The present invention relates to a packaging method of the print head chip of an inkjet cartridge and its structure. More particularly, the invention relates to an inkjet cartridge for inkjet printing devices, which packages the print head chip onto the ink cartridge in such a way that the print head chip can be free from ink corrosion.

2. Related Art

Using inkjet cartridges in printing devices has been widely know for a long time. Examples of their applications include office inkjet printers, textile printing machines, color coating on color filters of optical elements, organic light-emitting diodes (OLEDs) or polymer light-emitting diode (PLED) manufacturing apparatuses.

The basic structure of a conventional inkjet cartridge is shown in FIG. 1. It consists of an ink cartridge 10 and a print head chip 20. The ink cartridge 10 is made of a corrosion-resistant plastic material whose bottom has an ink outlet 11. The print head chip 20 is packaged by glue 12 at the ink outlet 11. The glue 12 has to tightly package the print head chip 20 at the ink outlet 11 of the ink cartridge 10. Aside from maintaining the back pressure in the ink channel at the back of the print head chip 20, it also has to ensure that the ink can be normally jetted out of the print head chip 20.

The conventional inkjet technique is to jet out the ink using drop-on-demand method. Usual jet methods include the thermal bubble type and the piezo-electrical type that eject ink out of the ejection nozzle of the print head chip.

In a typical thermal bubble type inkjet cartridge, the print head chip contains a thin film resistor. When the thin film resistor is heated, a small volume of ink droplet is rapidly vaporized and expanded to pass the ejection nozzle of the print head and to print a pattern of dots on a sheet of paper. In the piezo-electrical type cartridge, the print head chip uses the piezo-electrical property of piezo-electrical materials to control the expansion or contraction of the piezo-electrical material, thus ejecting ink droplets from the nozzle.

As inkjet printing technique applications receive more and more attention, the ink is also improved from a water-based solution to a solvent-based solution. However, the solvent-based solution often corrodes the ink cartridge material. It is thus crucial to use corrosion-resistant materials to make the container. In general, even though metals and print head chips have good joint property and can resist the corrosion of the solvent, however, it is not easy to use metal materials to make containers and the cost would be higher. Therefore, it is still more popular to use engineering plastic ejection molding as the material for ink cartridges. Nevertheless, most solvent corrosion-resistant materials are either more expensive, difficult for ejection molding, or uneasy to find proper glues for the joints. If the ink cartridge material uses improper glue, not only is the joint between the chip and the ink cartridge bad, the print head chip and the ink cartridge will also be depart from each other easily. All these factors give many limitations on the design and manufacturing of the inkjet cartridges.

### SUMMARY OF THE INVENTION

It is a primary object of the present invention to provide a packaging method for the print head chip of an inkjet cartridge, with which one can prevent from the problem of whether glue is suitable for ink cartridge materials and ensure that the print head chip will not depart from the ink cartridge due to the above-mentioned improper combination.

It is another object of the invention to provide a packaging structure for the print head chip of an inkjet cartridge, which can prevent from the trouble of selecting proper glue between the ink cartridge and the print head chip during the process of assembling the ink cartridge.

The disclosed method mainly utilizes a corrosion-resistant chip substrate between the ink cartridge and the print head chip so that the print head is not in direct contact with the ink cartridge through glue. In the process of packaging the ink cartridge, one then does not need to choose particular glue.

In the method, a preferred embodiment to join the chip substrate and the ink cartridge is to integrate the chip substrate into the ink cartridge ejection molding. The chip substrate is then simultaneously combined onto the ink cartridge without the need of any agent in between.

### BRIEF DESCRIPTION OF THE DRAWINGS

The present invention will become more fully understood from the detailed description given hereinbelow illustration only, and thus are not limitative of the present invention, and wherein:

FIG. 1 shows an exploded structure of a conventional inkjet cartridge;

FIG. 2 shows an exploded structure of the inkjet cartridge according to a first embodiment of the invention;

FIG. 3 is a cross-sectional view of the inkjet cartridge in FIG. 2 along the III-III line;

FIG. 4 shows an exploded structure of the inkjet cartridge according to a second embodiment of the invention;

FIG. 5 is a cross-sectional view of the inkjet cartridge in FIG. 4 along the V-V line;

FIG. 6 is a flowchart of the packaging method according to a first embodiment of the invention; and

FIG. 7 is a flowchart of the packaging method according to a second embodiment of the invention.

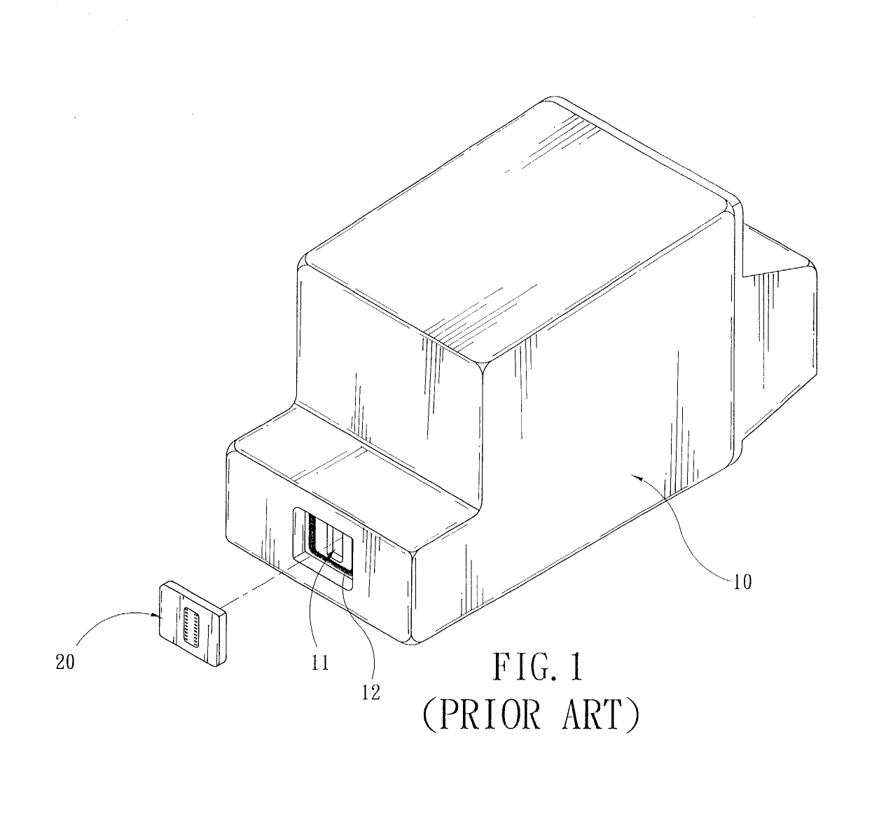

### DETAILED DESCRIPTION OF THE INVENTION

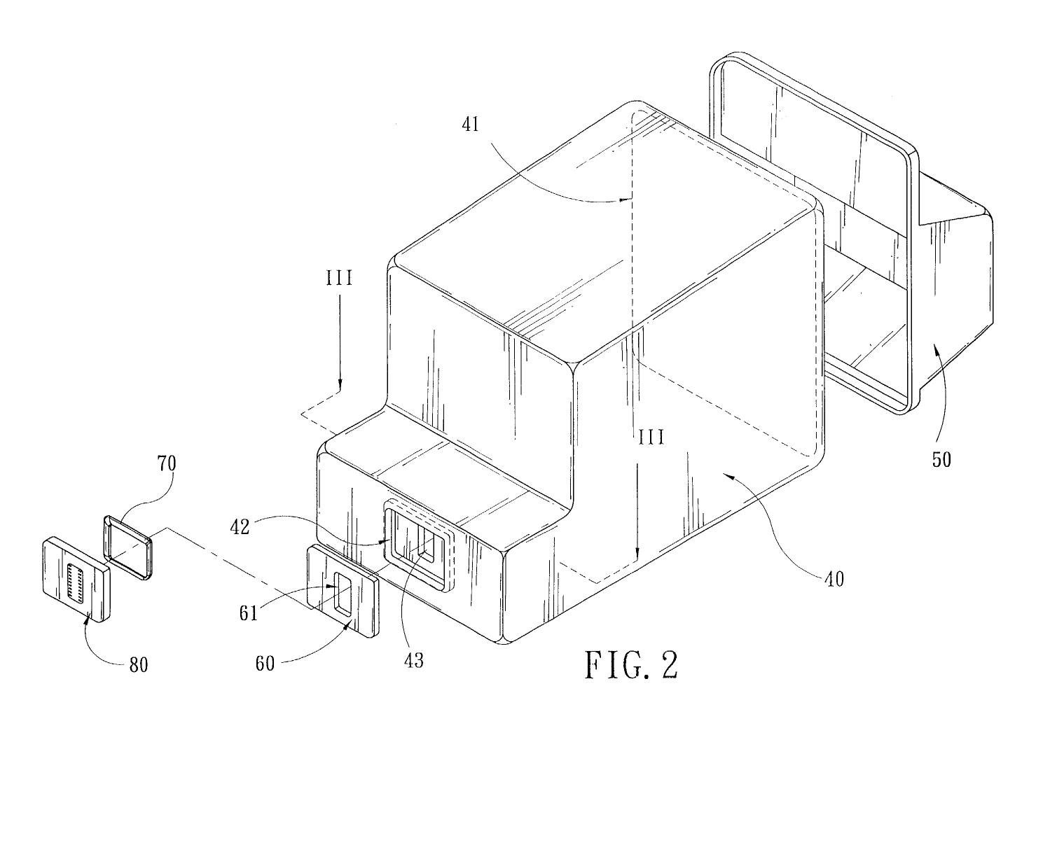

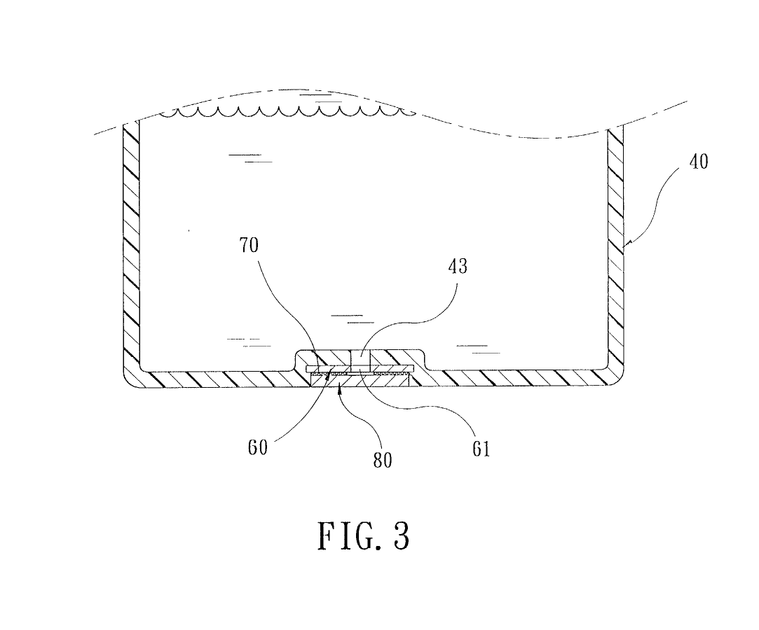

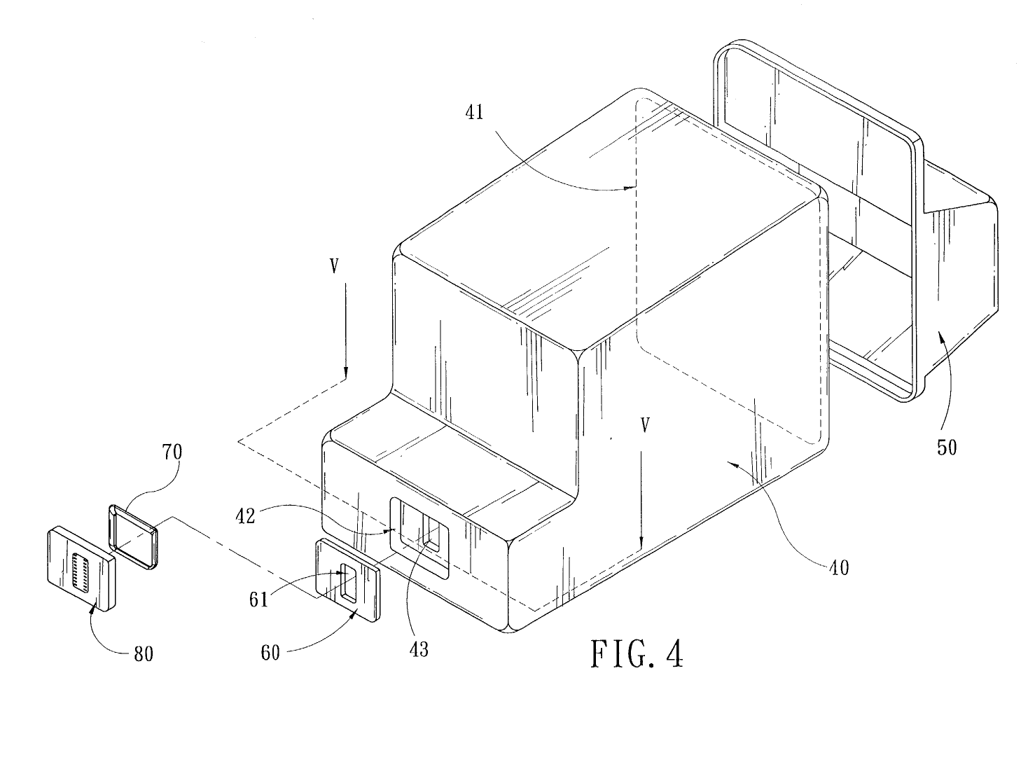

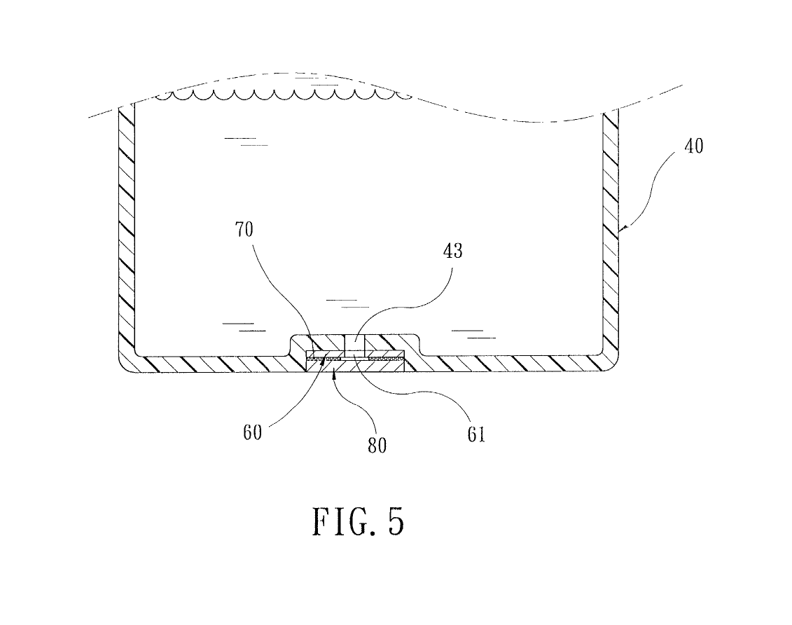

With reference to FIG. 2, the disclosed inkjet cartridge basically contains an ink cartridge 40, an upper covering 50, a chip substrate 60, glue 70, and a print head chip 80. The ink cartridge 40 is a container made of corrosion-resistant materials to store ink for inkjet printing. The top of the ink cartridge 40 has an opening 41 for refilling the ink. The upper covering 50 closes this opening 41. The bottom of the ink cartridge 40 has an ink outlet 42 in fluid communication with the ink in the ink cartridge 40 through an ink channel 43 (FIG. 3). The ink for printing is jetted out from the ink outlet 42. The chip substrate 60, the glue 70. and the print head chip 80 are assembled in order at the ink outlet 42 of the ink cartridge 40. This then forms an inkjet cartridge used in inkjet printing devices (such as inkjet printers or inkjet press machines). Such inkjet cartridges usually have an accumulator in their interiors so as to adjust the internal pressure of the inkjet cartridge. This ensures normal ink supply to the print head chip 80 and does not have the problem of ink leakage when the external pressure changes. Since this technology is not the concern of the present invention, this part will not be further described hereinafter. Related techniques can be found in, for example, the U.S. Pat. Nos. 5,409,134 and 5,988,803.

The main feature of the present invention is a corrosion-resistant chip substrate 60 installed at the ink outlet 42 of the ink cartridge 40. an ink channel 61 connecting to the ink outlet 42 (FIG. 3), and proper glue 70 (such as heat-curing glue) that joins a print head chip 80 and the chip substrate 60. The print head chip 80 is in fluid communication with the ink outlet 42 of the ink cartridge 40 through the ink channel 61.

In the disclosed packaging structure, the print head chip 80 is installed onto the ink cartridge 40 through the chip substrate 60. Therefore, there is no such problem of selecting proper glue 70 to put between the print head chip 80 and the ink cartridge 40 as in the prior art.

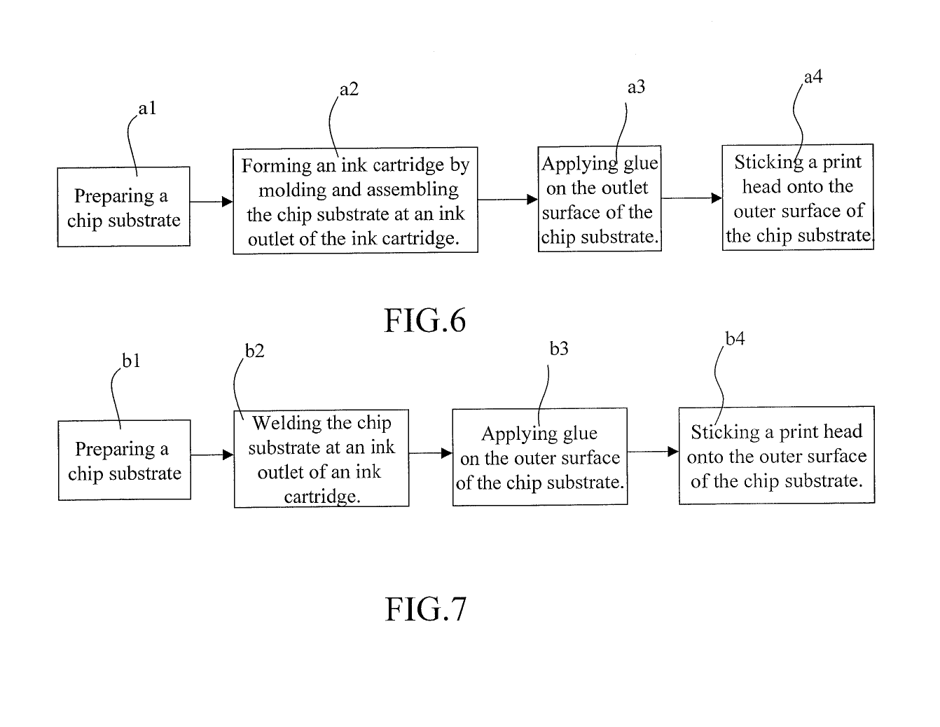

The steps of a preferred embodiment of the disclosed packaging method includes (FIG. 6):

a1) preparing a chip substrate 60;

a2) forming an ink cartridge 40 by molding and assembling the chip substrate 60 at an ink outlet 43 of the ink cartridge 40;

a3) applying glue 70 on the outer surface of the chip substrate 60; and

a4) sticking a print head 80 onto the outer surface of the chip substrate 60.

In the above-mentioned first step, the ink cartridge 40 can be made of industrial plastic. The chip substrate 60 is made of solvent-resistant metals, or another industrial plastic. In principle, it is preferable to use industrial plastic that is different from the ink cartridge 40 and suitable for the glue 70. The ink cartridge 40 is manufactured using the plastic molding technology (such as ejection molding). The chip substrate 60 is disposed in the ejection mold at the same time. After the ejected material is cooled down and contracts, the chip substrate 60 is wrapped at the ink outlet 42 of the ink cartridge 40, with one surface of the chip substrate 60 exposed to the ambient environment. The rim of the exposed surface of the chip substrate 60 is applied with heat-curing glue 70 suitable for holding the print head chip 80. The print head chip 80 is disposed on the chip substrate 60. After heating and curing the heat-curing glue 70, the assembly of the print head chip 80 and the ink cartridge 40 is then finished (FIGS. 2 and 3). The ink outlet 42 already covered with the chip substrate 60 is preferable to be in a concave shape for the storage and packaging of the print head.

The steps of another preferred embodiment of the disclosed packaging method includes (FIG. 7):

b1) preparing a chip substrate 60;

b2) welding the chip substrate 60 at an ink outlet 43 of an ink cartridge 40;

b3) applying glue 70 on the outer surface of the chip substrate 60; and

b4) sticking a print head 80 onto the outer surface of the chip substrate 60.

In the second packaging method, the ink outlet 42 of the ink cartridge 40 is preferable in a concave shape. The chip substrate 60 is disposed in the concave ink outlet 42. It is combined with the ink outlet 42 of the ink cartridge 40 by ultrasonic or heat welding. The installed chip substrate 60 will have a side surface exposed to the ambient environment. The rim of the exposed surface is applied with heat-curing glue 70 suitable for holding the print head chip 80. The print head chip 80 is then disposed on the chip substrate 60. Finally, the heat-curing glue 70 is heated and cured to finish up the packaging of the print head chip 80 and the ink cartridge 40.

### EFFECTS OF THE INVENTION

Through the means of inserting a corrosion-resistant chip substrate between an ink cartridge and a print head chip, the print head chip is not directly glued onto the ink cartridge. The present invention is then free from the limitation of whether the glue is suitable for the inkjet cartridge material and ensures that the print head will not depart from the ink cartridge because of the above-mentioned reason.

According to the disclosed packaging method, the chip substrate installation can be integrated into the plastic molding process of the ink cartridge. The process is fast and can have a better tightness.

Certain variations would be apparent to those skilled in the art, which variations are considered within the spirit and scope of the claimed invention.

What is claimed is:

1. A packaging method for installing a print head chip at an ink outlet of an inkjet cartridge, which comprises the steps of:
preparing a chip substrate, which has an ink channel connecting to the ink outlet of the ink cartridge;
forming an ink cartridge by molding and disposing the chip substrate in a mold for forming the ink cartridge so that the chip substrate is installed at the ink outlet of the ink cartridge at the same time the ink cartridge is formed and has at least one side surface exposed to the ambient environment;
applying glue on the exposed surface of the chip substrate; and
sticking a print head onto the glue on the chip substrate surface.

2. The method of claim 1, wherein the chip substrate material is selected to be compatible with the glue property.

3. A packaging method for installing a print head chip at an ink outlet of an inkjet cartridge, which comprises the steps of:
preparing a chip substrate, which has an ink channel connecting to the ink outlet of the ink cartridge;
installing the chip substrate at an ink outlet of an ink cartridge by a welding means, with at least one side surface exposed to the ambient environment;
applying glue on the exposed surface of the chip substrate; and
sticking a print head onto the glue on the chip substrate surface.

4. The method of claim 3, wherein the welding means is heat welding.

5. The method of claim 3, wherein the welding means is ultrasonic welding.

6. The method of claim 3, wherein the chip substrate material is selected to be compatible with the glue property.

7. A packaging structure for a print head chip of an inkjet cartridge, which comprises:
an ink cartridge, which is a container made of an ink corrosion-resistant material and has one ink outlet for releasing ink contained therein;
a chip substrate installed at the ink outlet, which has one ink channel connecting to the ink outlet and at least one side surface exposed to the ambient environment; and
a print head chip, which is glued onto the exposed surface of the chip substrate for ink ejection.

8. The packaging structure of claim 7, wherein the ink cartridge is made of industrial plastic.

9. The packaging structure of claim 7, wherein the chip substrate is made of a metal.

10. The packaging structure of claim 7, wherein the chip substrate is made of industrial plastic that is different from the ink cartridge material and compatible with the glue.

11. The packaging structure of claim 7, wherein the glue is heat-curing glue.
